(19) United States
(12) Patent Application Publication
(10) Pub. No.: US 2016/0148133 A1
(43) Pub. Date: May 26, 2016

(54) RISK ASSESSMENT THROUGH CONTEXTUAL ANALYSIS

(71) Applicant: INTERNATIONAL BUSINESS MACHINES CORPORATION, Armonk, NY (US)

(72) Inventors: Peter F. Haggar, Raleigh, NC (US); Elizabeth V. Woodward, Cedar Park, TX (US); Shunguo Yan, Austin, TX (US)

(21) Appl. No.: 14/554,299

(22) Filed: Nov. 26, 2014

(51) Int. Cl. G06Q 10/06

(52) U.S. Cl. CPC G06Q 10/0635; G06Q 10/063112

(57) ABSTRACT

In an approach to assessing risk, one or more computer processors retrieve a profile associated with a first user, wherein the first user is a resource associated with at least one task of a project. The one or more computer processors retrieve one or more activities associated with the first user, based on the profile associated with the first user, including one or more activities associated with the project and one or more activities not associated with the project. The one or more computer processors perform a risk analysis of the project, based, at least in part, on the one or more activities associated with the first user. The one or more computer processors determine whether one or more risks to the project are identified. Responsive to determining one or more risks are identified, the one or more computer processors recommend one or more risk reduction activities.

### BACKGROUND OF THE INVENTION

The present invention relates generally to the field of risk assessment, and more particularly to assessing and managing risk through contextual analysis.

Project management software is a commonly used business tool. Project management software is a term that may be used to cover many types of software used to control the scheduling, budget management, resource allocation, and/or quality management of complex projects. One common feature of project management software is the scheduling of tasks. Some scheduling challenges may include defining how the tasks depend on one another, scheduling resources required by the various tasks, estimating the duration of each task, and arranging the tasks to meet various deadlines.

Risk is the effect of uncertainty on objectives, whether positive or negative. Risk management, therefore, refers to the identification, assessment, and prioritization of risks followed by coordinated and economical application of resources to minimize, monitor, and control the probability and/or impact of unfortunate events or to maximize the realization of opportunities. In many projects, a risk analysis is completed for the project. The risk analysis permits the team working on the project to identify and evaluate the potential problems or risks that are associated with that project. Risk factors for projects can be divided into two groups: direct and project related, such as a hardware shortage or power outage; and indirect and non-project related, such as social activity, sick leave, or unanticipated requests for non-project attention of critical resources assigned to work items.

### SUMMARY

Embodiments of the present invention disclose a method, a computer program product, and a system for assessing risk. The method may include one or more computer processors retrieving a profile associated with a first user, where the first user is a resource associated with at least one task of a project. The one or more computer processors retrieve one or more activities associated with the first user, based, at least in part, on the profile associated with the first user, including one or more activities associated with the project and one or more activities not associated with the project. The one or more computer processors perform a risk analysis of the project, based, at least in part, on the one or more activities associated with the first user. The one or more computer processors determine whether one or more risks to the project are identified. Responsive to determining one or more risks are identified, the one or more computer processors recommend one or more risk reduction activities.

### BRIEF DESCRIPTION OF THE SEVERAL VIEWS OF THE DRAWINGS

FIG. 1 is a functional block diagram illustrating a distributed data processing environment, in accordance with an embodiment of the present invention;

FIG. 2 is a flowchart depicting operational steps of a risk analysis engine, on a server computer within the distributed data processing environment of FIG. 1, for evaluating risk through contextual analysis, in accordance with an embodiment of the present invention;

FIG. 3 illustrates an example of the risk analysis engine, running on the server computer within the distributed data processing environment of FIG. 1, in accordance with an embodiment of the present invention; and

FIG. 4 depicts a block diagram of components of the server computer executing the risk analysis engine within the distributed data processing environment of FIG. 1, in accordance with an embodiment of the present invention.

### DETAILED DESCRIPTION

Project management tools provide scheduling based on inputs provided by a user or a project manager. Inputs typically consist of a plan schedule that indicates the start and end dates and the sequence of work items in the plan. The project management tool determines the plan schedule by including information such as effort estimate or duration of work items, start and end date of the plan, schedule constraints and dependencies of work items, project working days and hours, and availability of resources, i.e. project team members, assigned to the work items. Project management tools may not take into consideration a project team member's responsibilities outside of the project. For example, there may be something significant on a team member's calendar between the start and end date of a project work item that can affect the team member's ability to complete the work item in the allotted time. By not taking team members' total responsibilities into account, project management tools cannot identify work items that are “at risk” of not being completed on time. In addition, if a work item becomes “at risk”, project management tools do not suggest how to reduce or eliminate the risk.

Embodiments of the present invention recognize that efficiency can be gained by incorporating a holistic view of project team members' availability and predicted availability into project management tools to assess and mitigate risk. Implementation of embodiments of the invention may take a variety of forms, and exemplary implementation details are discussed subsequently with reference to the Figures.

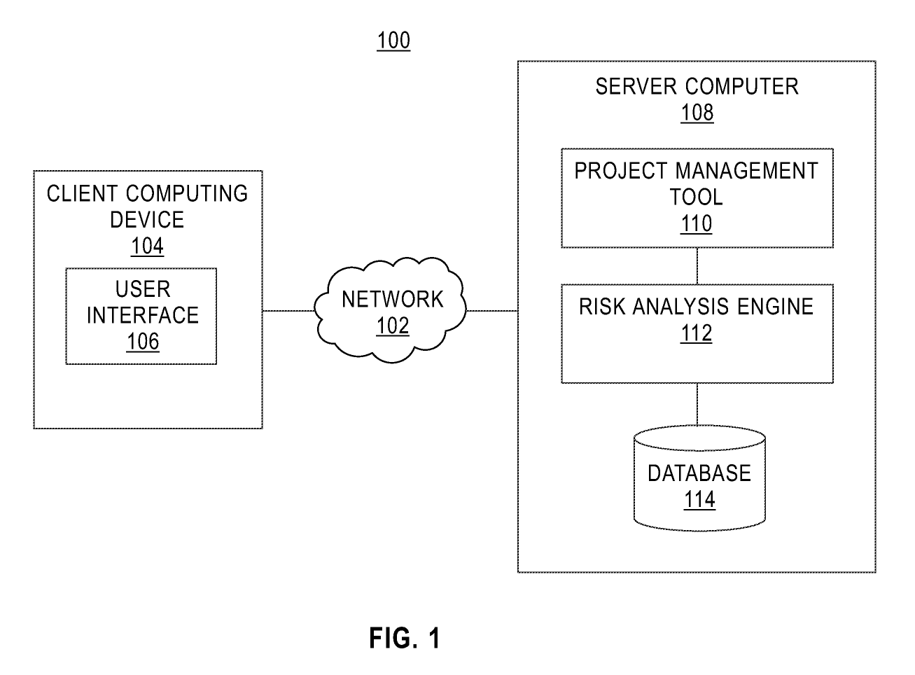

FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes client computing device 104 and server computer 108 interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information.

Client computing device 104 can be a desktop computer, a laptop computer, a tablet computer, a specialized computer server, a smart phone, or any programmable electronic device capable of communicating with server computer 108 via network 102 and with various components and devices within distributed data processing environment 100. In general, client computing device 104 represents any programmable electronic device or combination of programmable electronic devices capable of executing machine readable program instructions and communicating with other computing devices via a network, such as network 102. Client computing device 104 can represent one or more client computing devices, used by a project manager or multiple project team members simultaneously. Client computing device 104 includes user interface 106.

User interface 106 provides an interface between a user of client computing device 104 and server computer 108. User interface 106 may be a graphical user interface (GUI) or a web user interface (WUI) and can display text, documents, web browser windows, user options, application interfaces, and instructions for operation, and includes the information (such as graphic, text, and sound) that a program presents to a user and the control sequences the user employs to control the program. User interface 106 may also be mobile application software that provides an interface between a user of client computing device 104 and server computer 108. Mobile application software, or an “app”, is a computer program designed to run on smart phones, tablet computers and other mobile devices. User interface 106 enables a user of client computing device 104 to monitor risk and interact with server computer 108.

Server computer 108 can be a management server, a web server, or any other electronic device or computing system capable of receiving and sending data. In other embodiments, server computer 108 can represent a server computing system utilizing multiple computers as a server system, such as in a cloud computing environment. In another embodiment, server computer 108 can be a laptop computer, a tablet computer, a netbook computer, a personal computer (PC), a desktop computer, a personal digital assistant (PDA), a smart phone, or any programmable electronic device capable of communicating with client computing device 104 via network 102. In another embodiment, server computer 108 represents a computing system utilizing clustered computers and components to act as a single pool of seamless resources. Server computer 108 includes project management tool 110, risk analysis engine 112, and database 114.

Project management tool 110 is an example of project management software known in the art. Project management software has the capacity to help plan, organize, and manage resource pools and develop resource estimates. Depending on the sophistication of the software, project management software can manage estimation and planning, scheduling, cost control and budget management, resource allocation, collaboration software, communication, decision-making, quality management and documentation or administration systems. In one embodiment, project management tool 110 resides on server computer 108. In another embodiment, project management tool 110 may reside on client computing device 104, or any other client computing device in distributed data processing environment 100.

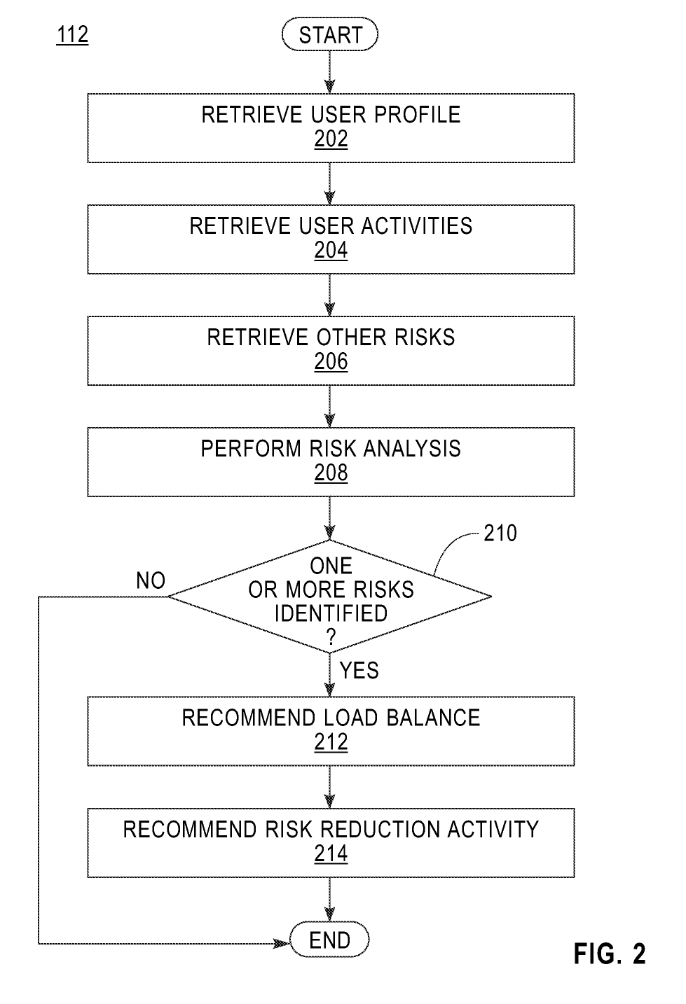

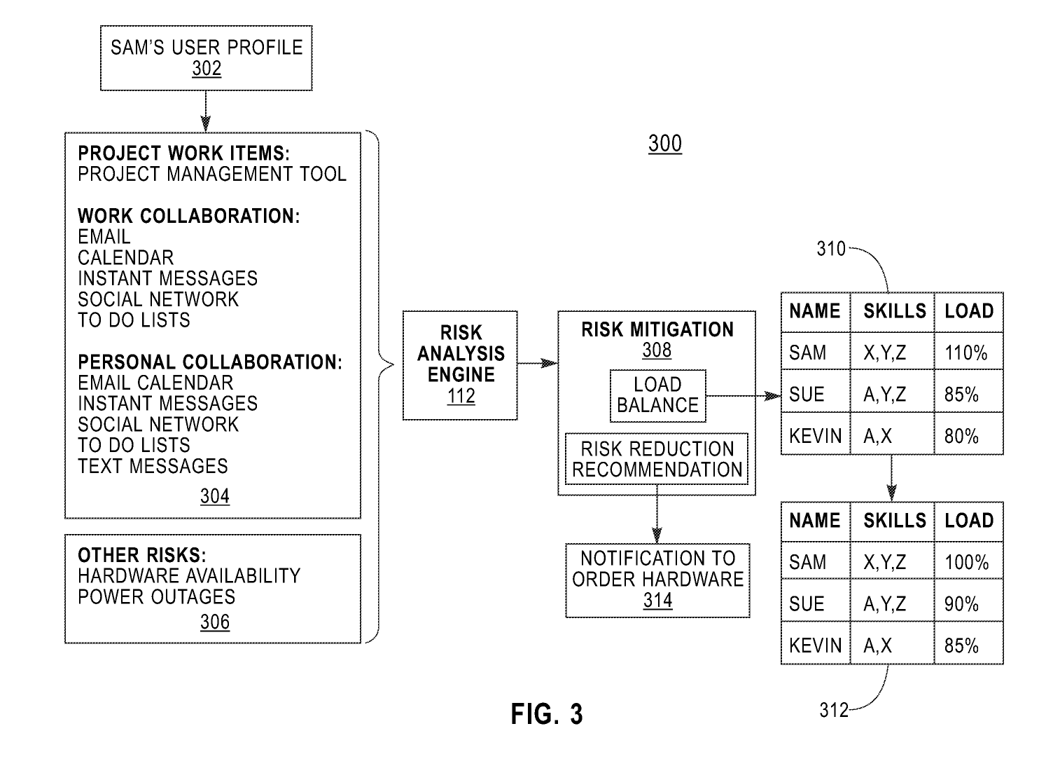

Risk analysis engine 112 identifies “at risk” work items, or tasks, in a project plan by considering various aspects of a team member's responsibilities and time consuming activities in addition to the project. Risk analysis engine 112 retrieves a user's activities for contextual analysis of day to day plans. Risk analysis engine 112 may identify non-project related tasks by rule processing which matches text from one or more data sources against project task information and identifies the information found in the one or more data sources as a user's non-project related commitments. Risk analysis engine 112 may analyze a user's work email, work calendar, and work instant messages to look for assignments in addition to the project. Risk analysis engine 112 may also analyze a user's personal email, personal calendar, and social networking activities to determine whether the user has time commitments outside of work. Risk analysis engine 112 merges both project and non-project related commitments in the workflow management performed by project management tool 110 to produce a view of the combined responsibilities of a user. Risk analysis engine 112 can also determine whether any direct or project related risks exist. If risk analysis engine 112 determines that one or more work items are at risk of not meeting plan requirements, then risk analysis engine 112 makes recommendations for risk mitigation. In one embodiment, risk analysis engine 112 is a standalone program. In another embodiment, risk analysis engine 112 may be integrated into project management tool 110. In one embodiment, a project manager executes risk analysis engine 112 to monitor each of the members of the project team to determine whether any risks to the project schedule exist and how to mitigate the risks if risks arise. In another embodiment, individual project team members may execute risk analysis engine 112 in order to monitor any risks to the project plan due to the individual's schedule. In a further embodiment, risk analysis engine 112 can be used for non-project management related risk assessments. For example, risk analysis engine 112 may analyze a workload distribution among trainees, and determine whether a mentor's work items are at risk of not meeting a schedule due to attention needed by the trainees. Risk analysis engine 112 is depicted and described in further detail with respect to FIG. 2 and FIG. 3.

Database 114 resides on server computer 108. In another embodiment, database 114 can reside on client computing device 104 or elsewhere in the environment. A database is an organized collection of data. Database 114 can be implemented with any type of storage device capable of storing data that can be accessed and utilized by server computer 108, such as a database server, a hard disk drive, or a flash memory. In other embodiments, database 114 can represent multiple storage devices within server computer 108. Database 114 stores project plans, including a schedule, work items, and resources assigned to the work items. Database 114 also stores project team members' names and associated skills and workloads. Database 114 stores user profiles of project team members. User profiles include links to data sources for risk analysis engine 112. Data sources may include work item databases, work and personal calendars, work and personal email accounts, work and personal instant message and text message accounts, work and personal to do lists, and social media accounts. Data sources may also include corporate databases such as a vacation database, a leave of absence database, and an activity participant database. In addition, data sources may include a telephone conversation, a text document, and a corporate message. The output of an analytics engine that indicates resource availability or commitments associated with a specific period of time may also be a data source. User profiles may also include rules defining recognition of items to be prioritized. For example, an instant message from a user's boss is answered within one hour, while an email from a coworker not associated with the project is answered within one week. Database 114 may also store an enterprise's supply chain information. In addition, database 114 may also store an enterprise's maintenance schedule.

FIG. 2 is a flowchart depicting operational steps of risk analysis engine 112, on server computer 108 within distributed data processing environment 100 of FIG. 1, for evaluating risk through contextual analysis, in accordance with an embodiment of the present invention.

Risk analysis engine 112 retrieves a user profile (step 202). Risk analysis engine 112 retrieves a user's profile from database 114 to link to the sources of data stored in the profile. Sources of data include one or more electronic databases or systems that include data that may indicate any activities that account for the user's available time during the duration of one or more work items of a project for which the user is responsible.

Risk analysis engine 112 retrieves user activities (step 204). Risk analysis engine 112 links to the data sources that include the user's time commitments. Risk analysis engine 112 links to the project plan to assess the work items assigned to the user and the start and end dates of the assignments. Risk analysis engine 112 collects any activities that may pose an indirect risk to the project by occurring during the time frame of the project. For example, risk analysis engine 112 may link to the user's work calendar to contextually analyze any meetings the user is required to attend and determine whether the meetings are not associated with the project. In another example, risk analysis engine 112 may link to the user's social networking accounts to retrieve activities outside of work that account for the user's time between the start and end date of a work item. Risk analysis engine 112 may execute analytics during the retrieval of user activities. For example, risk analysis engine 112 may retrieve and analyze the user's emails and chats using natural language processing methods and rule processing to determine the urgency of any activities mentioned. In another example, risk analysis engine 112 may retrieve and analyze the user's files, such as word processing files, spreadsheets, presentations, text, etc., using natural language processing methods and rule processing to identify non-project related activities. In a further example, risk analysis engine 112 may retrieve and analyze a corporate message of a format recognized by rule processing that matches one or more attributes of the format to text or patterns that identify the contents of the message as a non-project related activity.

Risk analysis engine 112 retrieves other risks (step 206). Risk analysis engine 112 retrieves other direct, project-related risk factors from database 114. For example, risk analysis engine 112 may link to an enterprise supply chain system and determine that there is a shortage of hardware required by the project. In another example, risk analysis engine 112 may link to an enterprise maintenance system and determine that a power outage is planned for a period of time that can impact one or more of the project's work items.

Risk analysis engine 112 performs a risk analysis (step 208). Risk analysis engine 112 performs a risk analysis by comparing a user's total responsibility environment to the user's assigned project work items and determining whether the user has sufficient time to complete one or more project tasks by the specified end dates. The risk analysis may include one or more of the following: a risk of project completion, an identification of resource limitations and deficiencies, a “what if” analysis, a re-calculation of workflow (e.g., re-scheduling, parallel processing), and a recommendation of a workload rebalance. In one embodiment, risk analysis engine 112 predicts future bottlenecks based on a history of a user's overall activities. For example, risk analysis engine 112 may determine, by contextual analysis of a user's work and personal calendars, that Wednesdays are very busy for the user. Therefore, if the user has not completed a pre-defined percentage of work by mid-day on Tuesday, then the items targeted for completion on Thursday are at risk. Risk analysis engine 112 also compares any retrieved direct risk factors, such as a hardware shortage or power outage, to the project plan to determine whether the direct risk factors pose a risk to the project schedule. In one embodiment, risk analysis engine 112 looks across multiple projects and team members in a matrixed environment to perform the risk analysis.

Risk analysis engine 112 determines whether one or more risks are identified (decision block 210). Risk analysis engine 112 determines whether the risk analysis, performed in step 208, identifies any risks to the project plan. Identified risks to the project plan may include any items that can cause the project to delay a schedule or a milestone, or overrun a budget. If risk analysis engine 112 does not identify one or more risks (“no” branch, decision block 210), then risk analysis engine 112 ends the risk analysis process.

If risk analysis engine 112 identifies one or more risks (“yes” branch, decision block 210), then risk analysis engine 112 recommends a load balance (step 212). If risk analysis engine 112 identifies a risk to the project schedule due to a user's time commitments on project related and/or non-project related activities exceeding a pre-defined threshold, then risk analysis engine 112 retrieves information regarding other project team members from database 114. Risk analysis engine 112 analyzes skills and workload of other project team members to determine if another project team member can pick up a work item from the user that is at risk of missing a deadline. In one embodiment, risk analysis engine 112 sends an alert to the project manager, via user interface 106, informing the project manager of the risk and the recommended load balance. In another embodiment, risk analysis engine 112 may alter the appearance of an at risk work item in the project plan, and the project manager or a team member can click on the work item to review the load balance recommendation. In an embodiment, if risk analysis engine 112 cannot determine a suitable load balance recommendation, then risk analysis engine 112 does not recommend a load balance. In an embodiment where no other project team members have the same skills as the user, or where there are no other team members, risk analysis engine 112 does not recommend a load balance. In one embodiment, if risk analysis engine 112 does not recommend a load balance, then risk analysis engine 112 notifies the project manager, via user interface 106, that a team member's workload is above a pre-defined threshold, but no load balance recommendation is available.

Risk analysis engine 112 recommends risk reduction activity (step 214). In addition to load balancing, risk analysis engine 112 recommends one or more risk reduction activities with regards to direct risk factors. Risk analysis engine 112 may choose one or more users to notify with the recommended risk reduction activity. For example, if risk analysis engine 112 determines from analyzing an enterprise supply chain system that a hardware shortage exists, then risk analysis engine 112 may send an alert to the project manager, via user interface 106, to order more hardware. In another example, if risk analysis engine 112 determines from analyzing the enterprise maintenance schedule that a four hour power outage is planned on a particular day, then risk analysis engine 112 may send an alert to potentially impacted project team members, via user interface 106, to work a different shift on the day of the power outage. If risk analysis engine 112 determines a major factor for the risk is due to a user spending time on another activity, such as social networking, then risk analysis engine 112 can recommend to reduce the time in such activity. In an embodiment, if risk analysis engine 112 cannot determine a suitable risk reduction activity recommendation, then risk analysis engine 112 does not recommend a risk reduction activity. In one embodiment, if risk analysis engine 112 does not recommend a risk reduction activity, then risk analysis engine 112 notifies the project manager, via user interface 106, that a direct risk factor exists, but no risk reduction activity recommendation is available.

FIG. 3 illustrates an example of risk analysis engine 112, running on server computer 108 within distributed data processing environment 100 of FIG. 1, in accordance with an embodiment of the present invention.

Diagram 300 depicts risk analysis engine 112 of FIG. 1 analyzing and determining at risk work items for a user named Sam. Sam's user profile 302 includes links to programs and systems that account for Sam's time during a period in which Sam is working on a project. Activities 304 lists the links in Sam's user profile 302. Activities 304 includes project work items that risk analysis engine 112 retrieves from the project plan in project management tool 110 of FIG. 1. Activities 304 also includes work collaboration items. Risk analysis engine 112 retrieves work collaboration items from database 114 of FIG. 1 by linking to Sam's work email, work calendar, work instant messages, work social networks, and work to do lists. Activities 304 also includes personal collaboration items. Risk analysis engine 112 retrieves personal collaboration items from database 114 of FIG. 1 by linking to Sam's personal email, personal calendar, personal instant messages, personal social networks, personal to do lists, and personal text messages. Risk analysis engine 112 also retrieves items from other risks 306. Other risks 306 includes items outside of activities 304 that may impact the project. Other risks 306 includes hardware availability and power outages.

As discussed with respect to step 208 of FIG. 2, risk analysis engine 112 performs a risk analysis and identifies risks associated with the project. In the example of diagram 300, risk analysis engine 112 has determined that two risks are present. Risk analysis engine 112 has determined that Sam's workload is scheduled to take over 100% of his time in the analyzed period. Also, risk analysis engine 112 has determined that a hardware shortage exists. Risk mitigation 308 lists the risk reduction activities that risk analysis engine 112 recommends. Risk mitigation 308 shows a recommended load balance. Current workload table 310 lists team members Sam, Sue, and Kevin, and the skills and workload associated with each person. Current workload table 310 indicates that risk analysis engine 112, by contextual analysis of activities 304, determines Sam's workload is 110%, regardless of whether or not the activities apply to the project. In addition, risk analysis engine 112 looks across the project, analyzes the workloads of other team members, and determines that Sue and Kevin, who share similar skills to Sam, have workloads under 100%. Recommended workload table 312 indicates the load balance that risk analysis engine 112 recommends. Recommended workload table 312 indicates Sam's workload is down to 100% such that Sam can meet his project commitments. Sue's and Kevin's workloads are increased by taking on some of Sam's work items, but neither Sue's nor Kevin's workloads are over 100%. In the example, risk analysis engine 112 sends a notification to the project manager to recommend the change in work assignments between the project team members.

In addition to the load balance, risk mitigation 308 shows a risk reduction recommendation that is not related to workload. In response to determining that a hardware shortage exists, risk analysis engine 112 recommends risk reduction activity 314. Risk reduction activity 314 is a notification to the project manager, via user interface 106, that the hardware shortage exists and a recommendation to order additional hardware.

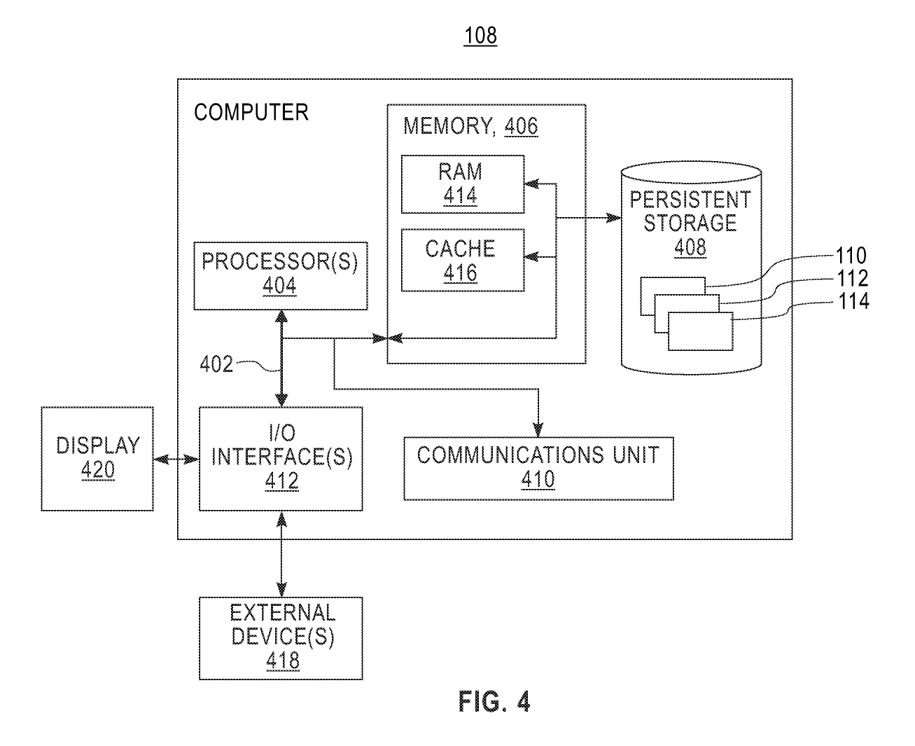

FIG. 4 depicts a block diagram of components of server computer 108 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Server computer 108 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 414 and cache memory 416. In general, memory 406 can include any suitable volatile or non-volatile computer readable storage media.

Project management tool 110, risk analysis engine 112, and database 114 are stored in persistent storage 408 for execution and/or access by one or more of the respective computer processor(s) 404 via one or more memories of memory 406. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of client computing device 104. In these examples, communications unit 410 includes one or more network interface cards. Communications unit 410 may provide communications through the use of either or both physical and wireless communications links. Project management tool 110, risk analysis engine 112, and database 114 may be downloaded to persistent storage 408 through communications unit 410.

I/O interface(s) 412 allows for input and output of data with other devices that may be connected to server computer 108. For example, I/O interface(s) 412 may provide a connection to external device(s) 418 such as a keyboard, a keypad, a touch screen, a microphone, a digital camera, and/or some other suitable input device. External device(s) 418 can also include portable computer readable storage media such as, for example, thumb drives, portable optical or magnetic disks, and memory cards. Software and data used to practice embodiments of the present invention, e.g., project management tool 110, risk analysis engine 112, and database 114, can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for assessing risk, the method comprising:
retrieving, by one or more computer processors, a profile associated with a first user, wherein the first user is a resource associated with at least one task of a project;
retrieving, by the one or more computer processors, one or more activities associated with the first user, based, at least in part, on the profile associated with the first user, including one or more activities associated with the project and one or more activities not associated with the project;
performing, by the one or more computer processors, a risk analysis of the project, based, at least in part, on the one or more activities associated with the first user;
determining, by the one or more computer processors, whether one or more risks to the project are identified; and
responsive to determining one or more risks are identified, recommending, by the one or more computer processors, one or more risk reduction activities.

2. The method of claim 1, further comprising:
retrieving, by the one or more computer processors, one or more risks associated with the project that are not associated with the first user; and
determining, by the one or more computer processors, based, at least in part, on the one or more risks associated with the project that are not associated with the first user, at least one user to notify of the one or more risks.

3. The method of claim 1, wherein a profile associated with a first user includes links to data sources that describe at least one time consuming activity of the first user, including one or more of: a work item database, a work calendar, a personal calendar, a work email account, a personal email account, a work instant message account, a personal instant message account, a text message account, a work to do list, a personal to do list, a social media account, a corporate database, a vacation database, a leave of absence database, an activity participant database, a telephone conversation, a corporate message, and a file.

4. The method of claim 1, wherein a risk reduction activity includes at least a load balance.

5. The method of claim 4, wherein a load balance comprises:
determining, by the one or more computer processors, a workload associated with the first user, based, at least in part, on the one or more activities associated with the first user and one or more skills associated with the first user;
determining, by the one or more computer processors, one or more additional users with one or more associated skills the same as the one or more skills associated with the first user;
determining, by the one or more computer processors, a workload of the one or more additional users is less than the workload associated with the first user; and
recommending, by the one or more computer processors, assignment of one or more activities associated with the first user to the one or more additional users.

6. The method of claim 1, wherein a risk to the project includes at least a risk of missing a schedule requirement and a risk of missing a budget requirement.

7. The method of claim 1, wherein the one or more activities associated with the project and the one or more activities not associated with the project occur during a time frame including a start date and an end date of the project.

8. A computer program product for assessing risk, the computer program product comprising:
one or more computer readable storage media and program instructions stored on the one or more computer readable storage media, the program instructions comprising:
program instructions to retrieve a profile associated with a first user, wherein the first user is a resource associated with at least one task of a project;
program instructions to retrieve one or more activities associated with the first user, based, at least in part, on the profile associated with the first user, including one or more activities associated with the project and one or more activities not associated with the project;
program instructions to perform a risk analysis of the project, based, at least in part, on the one or more activities associated with the first user;
program instructions to determine whether one or more risks to the project are identified; and
responsive to determining one or more risks are identified, program instructions to recommend one or more risk reduction activities.

9. The computer program product of claim 8, further comprising:
program instructions to retrieve one or more risks associated with the project that are not associated with the first user; and
program instructions to determine, based, at least in part, on the one or more risks associated with the project that are not associated with the first user, at least one user to notify of the one or more risks.

10. The computer program product of claim 8, wherein a profile associated with a first user includes links to data sources that describe at least one time consuming activity of the first user, including one or more of: a work item database, a work calendar, a personal calendar, a work email account, a personal email account, a work instant message account, a personal instant message account, a text message account, a work to do list, a personal to do list, a social media account, a corporate database, a vacation database, a leave of absence database, an activity participant database, a telephone conversation, a corporate message, and a file.

11. The computer program product of claim 8, wherein a risk reduction activity includes at least a load balance.

12. The computer program product of claim 11, wherein a load balance comprises:
program instructions to determine a workload associated with the first user, based, at least in part, on the one or more activities associated with the first user and one or more skills associated with the first user;
program instructions to determine one or more additional users with one or more associated skills the same as the one or more skills associated with the first user;
program instructions to determine a workload of the one or more additional users is less than the workload associated with the first user; and
program instructions to recommend assignment of one or more activities associated with the first user to the one or more additional users.

13. The computer program product of claim 8, wherein a risk to the project includes at least a risk of missing a schedule requirement and a risk of missing a budget requirement.

14. The computer program product of claim 8, wherein the one or more activities associated with the project and the one or more activities not associated with the project occur during a time frame including a start date and an end date of the project.

15. A computer system for assessing risk, the computer system comprising:
one or more computer processors;
one or more computer readable storage media;
program instructions stored on the one or more computer readable storage media for execution by at least one of the one or more computer processors, the program instructions comprising:
program instructions to retrieve a profile associated with a first user, wherein the first user is a resource associated with at least one task of a project;
program instructions to retrieve one or more activities associated with the first user, based, at least in part, on the profile associated with the first user, including one or more activities associated with the project and one or more activities not associated with the project;
program instructions to perform a risk analysis of the project, based, at least in part, on the one or more activities associated with the first user;
program instructions to determine whether one or more risks to the project are identified; and
responsive to determining one or more risks are identified, program instructions to recommend one or more risk reduction activities.

16. The computer system of claim 15, further comprising:
program instructions to retrieve one or more risks associated with the project that are not associated with the first user; and
program instructions to determine, based, at least in part, on the one or more risks associated with the project that are not associated with the first user, at least one user to notify of the one or more risks.

17. The computer system of claim 15, wherein a profile associated with a first user includes links to data sources that describe at least one time consuming activity of the first user, including one or more of: a work item database, a work calendar, a personal calendar, a work email account, a personal email account, a work instant message account, a personal instant message account, a text message account, a work to do list, a personal to do list, a social media account, a corporate database, a vacation database, a leave of absence database, an activity participant database, a telephone conversation, a corporate message, and a file.

18. The computer system of claim 15, wherein a risk reduction activity includes at least a load balance.

19. The computer system of claim 18, wherein a load balance comprises:
program instructions to determine a workload associated with the first user, based, at least in part, on the one or more activities associated with the first user and one or more skills associated with the first user;
program instructions to determine one or more additional users with one or more associated skills the same as the one or more skills associated with the first user;
program instructions to determine a workload of the one or more additional users is less than the workload associated with the first user; and
program instructions to recommend assignment of one or more activities associated with the first user to the one or more additional users.

20. The computer system of claim 15, wherein the one or more activities associated with the project and the one or more activities not associated with the project occur during a time frame including a start date and an end date of the project.
